(19) United States
(12) Patent Application Publication
(10) Pub. No.: US 2019/0135601 A1
(43) Pub. Date: May 9, 2019

(54) TRAY LIFT SYSTEM

(71) Applicant: Rehrig Pacific Company, Los Angeles, CA (US)

(72) Inventors: Brian Robert Guerry, Huntington Beach, CA (US); Sydney Marie Ogawa-Garcia, Riverside, CA (US); Suzanne Clark Ward, Santa Monica, CA (US); Joshua D. Urban, Pasadena, CA (US); Dane Gin Mun Kalinowski, Foothill Ranch, CA (US); Travis James Englert, Brea, CA (US)

(21) Appl. No.: 16/149,383

(22) Filed: Oct. 2, 2018

Related U.S. Application Data
(60) Provisional application No. 62/567,218, filed on Oct. 2, 2017.

(51) Int. Cl. B66F 9/12; B65G 57/20

(52) U.S. Cl. CPC B66F 9/12; B65G 2201/0235; B65G 57/20

(57) ABSTRACT

A lift system includes a base and a vertical structure from which a plurality of tines projects. The tines are configured to engage a lower surface of a plurality of dairy trays within a stack of dairy trays in order to facilitate lifting part of a stack of dairy trays to access or remove a tray that is lower in the stack. In one embodiment, a plurality of pairs of tines are movable from a low position where they can engage a plurality of stacked trays to a raised position where there is space between each of the adjacent trays.

### BACKGROUND

Traditionally, milk has been transported in milk crates that have four one-gallon jugs and full depth, i.e. the full weight of a crate is supported on the walls of the crate below, not on the milk jugs. A recent development has been the transport of milk in trays that hold 12 one-gallon jugs and are low-depth (i.e. the weight of one tray is supported on the jugs of the tray below). This has been shown to be more efficient; however, the increase in weight is significant. Each tray may be approximately 100 pounds. Accessing milk on a lower tray, or up-stacking or down-stacking these trays requires multiple people.

### SUMMARY

Multiple embodiments of tray lifts are disclosed herein. Utilizing this equipment allows a single person to perform all of the necessary functions to the stack of product without additional help and labor costs. These functions may include up-stacking trays, down-stacking trays, manipulating layers in the stack to access particular trays, floor-stacking trays, holding a tray of product at an optimal height for ergonomics during unloading and transporting trays of product.

In one embodiment the tray lift is used in the cooler of a store where multiple stacks of milk trays are stored. When the store operator needs to replenish product on the cooler shelf, the lift can be used by this individual so the stack of trays can be manipulated to access the necessary size/flavor/etc. and loaded onto the retail shelf. The individual employee is able to manipulate the stack by lifting one or more 100 lb layers off the stack to access the product and load it on the retail shelf.

A lift system includes a base and a vertical structure from which a plurality of tines projects. The tines are configured to engage a lower surface of a plurality of dairy trays within a stack of dairy trays in order to facilitate lifting part of a stack of dairy trays to access or remove a tray that is lower in the stack.

In one embodiment, a plurality of pairs of tines are movable from a low position where they can engage a plurality of stacked trays to a raised position where there is space between each of the adjacent trays.

In one embodiment, a lift system includes a pair of vertical tracks. A plurality of tines extend horizontally outward from each of the vertical tracks. The plurality of tines are selectively movable upward on the vertical tracks. The vertical tracks may be mounted to a wall. Optionally, the plurality of tines are pivotably secured to the tracks so that they can fold toward the vertical tracks. The lift system is configured to engage a plurality of trays stacked on one another, so that each of the adjacent pair of the plurality of tines engages a different one of the plurality of trays. Each of the plurality of trays includes a base, a pair of opposed side walls extending upward from the base and a pair of opposed end walls extending upward from the base, and the base includes a raised periphery sized to receive one of the adjacent pair of the plurality of tines. The plurality of tines are movable from a low position where they can engage each of the trays in the stack to a raised position where the trays are not supported on one another. In the raised position, the contents of any of the trays can be removed.

A lift system according to another embodiment includes a base and vertical supports extending upward from the base. A plurality of pairs of rails are supported above the base by the vertical supports and project forward from the vertical supports. The rails slope upward to the vertical supports. The plurality of pairs of rails are spaced from one another to engage lower surfaces of trays stacked on one another.

A lift system according to another embodiment includes a base and an upright member extending upward from a rear portion of the base and pivotable relative to the base. A plurality of pairs of adjacent tines are pivotably secured to the upright member at points vertically spaced above the respective pair of adjacent tines. The plurality of pairs of adjacent tines project forward from the upright member. The upright member is pivotable from a leaning position to an upright position. The pairs of adjacent tines are vertically spaced from one another by a first distance when the upright member is in the leaning position and by a second distance, greater than the first distance, when the upright member is in the upright position. The lift system is configured to engage a plurality of trays each having a base and a plurality of walls extending upward from the base, such that each of the pair of adjacent tines engages a lower surface of one of the plurality of trays.

A lift system according to another embodiment includes a base and a vertical structure extending upward from the base. A front bracket is mounted to move vertically relative to the vertical structure. At least one tine bracket is mounted to the front bracket to move horizontally relative to the front bracket. A tine projects forward from each of the at least one tine bracket. The at least one tine bracket preferably includes a pair of tine brackets movable independently relative to the front bracket. The front bracket may include a plurality of notches engaged by the pair of tine brackets to secure the pair of tine brackets in each of a plurality of positions relative to the front bracket.

In the scenario when manipulating multiple adjacent stacks are not required, such as in a store cooler, and a single set of forks are used, then the fork positions can be adjusted to pick either stack. In this embodiment the fork positions are manually adjusted by sliding them horizontally along the carriage. The carriage could have preset locations for short wall or long wall picking of either left or right stacks, or on center. While this embodiment has manual adjustments along the carriage, future versions could have powered adjustment via lead/ball screws, motors, hydraulics, etc.

Other details and other embodiments are described in more detail below with respect to the following figures.

### BRIEF DESCRIPTION OF THE DRAWINGS

FIG. 1 illustrates a dairy tray of the type to be lifted by the tray lift systems disclosed herein.

FIG. 2 shows a first embodiment tray lift system for selectively separating the trays in the stack, with the tray lift system in the low position.

FIG. 3 shows the tray lift system and trays of FIG. 2 in the high position.

FIG. 4 is a front view of the system and trays of FIG. 2.

FIG. 5 is a front view of the system and trays of FIG. 3.

FIG. 6 shows an optional configuration of the tines of the lift system of FIGS. 2-5.

FIG. 7 is a side view of a lift system according to a second embodiment.

FIG. 8 shows the lift system of FIG. 7 in a mobile configuration behind a cooler.

FIG. 9 shows a lift system according to a third embodiment in a low position.

FIG. 10 shows the lift system of FIG. 9 in a high position.

FIG. 11 is a front view of the lift system and trays of FIG. 9.

FIG. 12 is a front view of the lift system and trays of FIG. 10.

FIG. 13 is a perspective view of the lift system and trays of FIG. 9.

FIG. 14 is a perspective view of the lift system and trays of FIG. 10.

FIG. 15 shows another embodiment of a lift system according to a fourth embodiment.

FIG. 16 is a side view of the lift system and trays of FIG. 15.

FIG. 17 is a front view of the lift system and trays of FIG. 15.

FIG. 18 is a front view of a lift system according to a fifth embodiment.

FIG. 19 is a side view of the lift system and trays of FIG. 18.

FIG. 20 is a perspective view of the lift system and trays of FIG. 18.

FIGS. 21-25 show a sequence of views showing the operation of a lift system according to a sixth embodiment.

FIG. 26 is a front view of a lift system according to a seventy embodiment, prior to engaging a dairy tray.

FIG. 27 is a perspective view of the lift system and dairy tray of FIG. 26.

FIGS. 28-31 show a sequence of views showing the operation of a lift system according to an eighth embodiment.

FIGS. 32-35 show a sequence of views showing the operation of a lift system according to a ninth embodiment.

FIG. 36 shows a lift system according to a tenth embodiment.

FIG. 37 shows the lift system of FIG. 37 with a tray.

FIG. 38 shows the lift system of FIG. 37 with the tines reconfigured to a second position.

FIG. 39 shows the lift system of FIG. 37 with the tines reconfigured to a third position.

FIG. 40 shows the lift system of FIG. 37 engaging one of two trays on a pallet.

FIG. 41 is a front view of the lift system and trays of FIG. 40.

### DETAILED DESCRIPTION

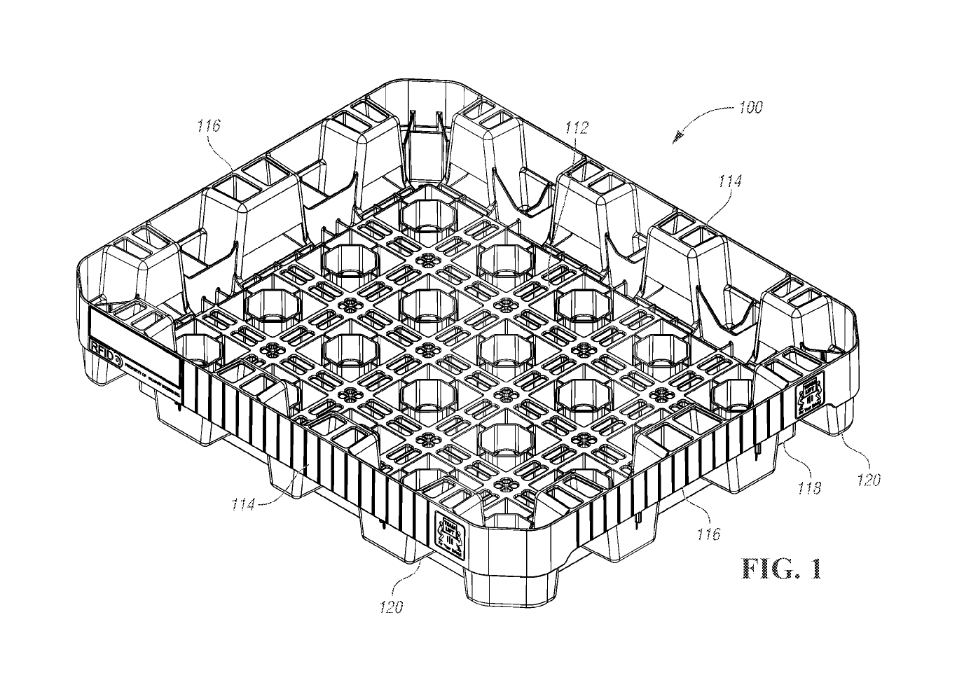

A dairy tray 100 is shown in FIG. 1. The tray 100 is formed as a single piece of plastic, such as by injection molding, but other methods could be used. The tray 100 includes a base 112, opposed side walls 114 and opposed end walls 116. A central portion 118 of the base 112 forms the lowest part of the tray 100 and leaves a raised periphery 120 of the tray 100 under which can be received fork tines. The example tray 100 is sized to receive twelve one-gallon milk jugs in a 4×3 array. The tray 100 could also be configured to receive twenty half-gallon milk jugs in a 4×5 array. In either event, the tray 100, loaded with milk jugs, is very heavy.

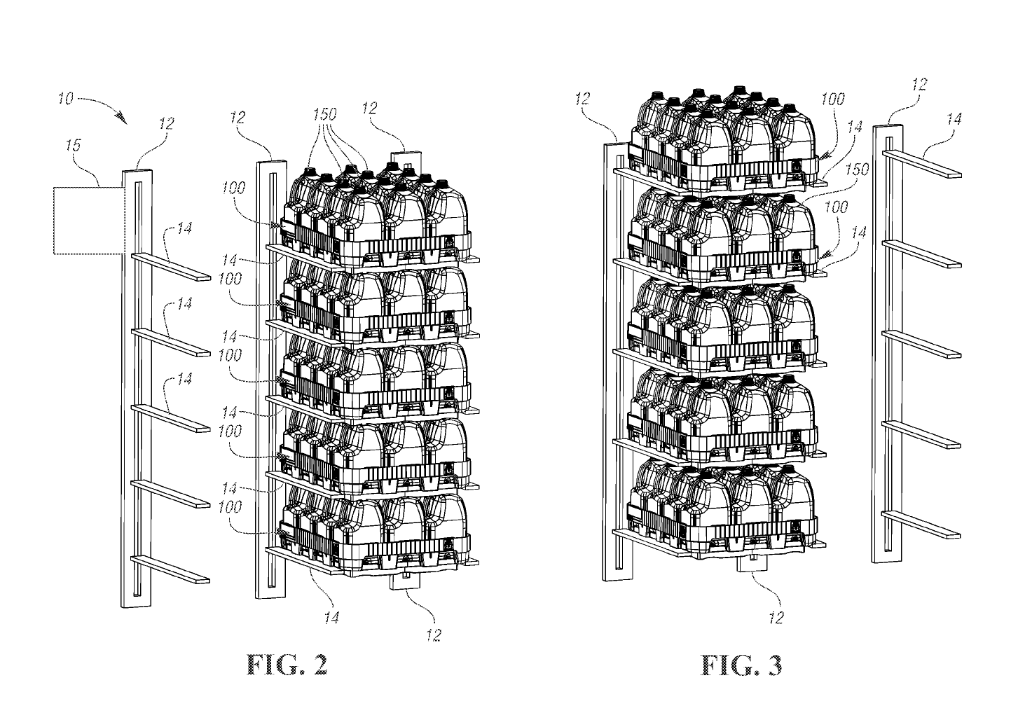

As shown in FIG. 2, when the trays 100 are loaded with milk jugs 150 and stacked, the trays 100 are supported directly on the jugs 150 in the tray 100 below. The tops of the jugs 150 are partially received in the bases 112 of the trays 100 stacked thereon. Should one of the milk jugs 150 or trays 100 lower in the stack become damaged, it would be difficult to lift the trays 100 above it to remove the damaged jug 150 or tray 100.

FIG. 2 shows a first embodiment tray lift system 10 for selectively separating the trays 100 in the stack. The system 10 includes a plurality of tracks 12 secured to a wall (or other vertical structure). Each of the tracks 12 movably supports a plurality of tines 14. The tines 14 can be raised or lowered on the tracks 12. FIG. 2 shows the stack of trays 100 in the stacked position, with the tines 14 individually engaging the trays 100. This could be arranged, for example, by driving a sled loaded with trays 100 toward the system 10, aligning the tines 14 under each of the raised peripheries 120 of the trays 100. A lift mechanism 15 (one shown) engages the tines 14 in each of the tracks 12 to selectively move the tines 14 between the positions shown in FIG. 2 and the positions shown in FIG. 3. The lift mechanism may include hydraulics, electric motors, manual linkages providing mechanical advantage, pneumatics, etc.

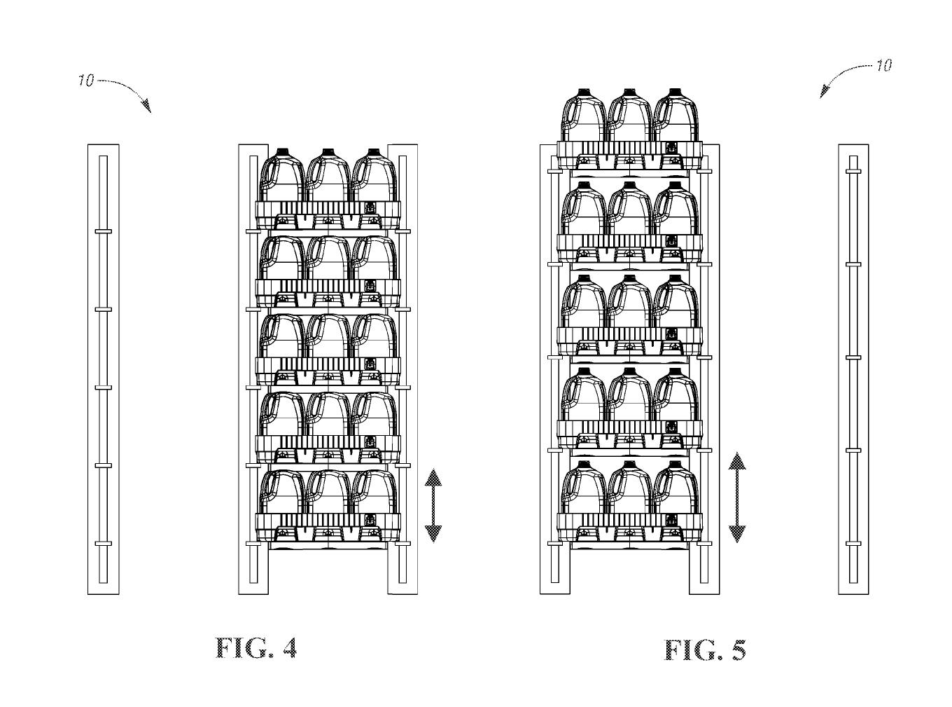

After the tines 14 are aligned under the trays 100 in FIG. 2, adjacent pairs of adjacent tines 14 may be lifted by the lift mechanism 15 from a low position to a raised position. The tines 14 are automatically lifted by the lift mechanism 15 until the bases 112 of the trays 100 are no longer engaging the tops of the jugs 150 therebelow, as shown in FIG. 3. In FIGS. 3 and 5, each tray 100 is spaced further away from the trays above and below than it was in FIGS. 2 and 4. In FIGS. 3 and 5, none of the trays 100 are contacting the tops of the jugs 150 therebelow. In FIGS. 2 and 4, the trays 100 are spaced from one another by a first distance, as they are stacked upon the jugs of the tray 100 below. In FIGS. 3 and 5, the trays 100 are spaced from one another by a second distance, greater than the first distance. In this raised position, any of the jugs 150 and/or trays 100 can be lifted, removed and replaced. The tines 14 can then be returned to the stacked position of FIG. 2, returned to the sled, etc. FIGS. 4 and 5 are front views of the system 10 of FIGS. 2 and 3, respectively.

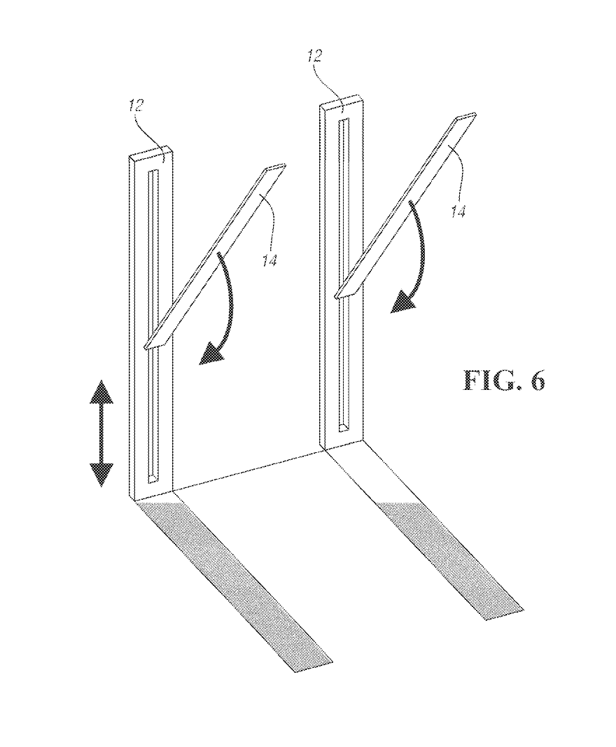

As shown in FIG. 6, the tines 14 may optionally be pivotably secured to the tracks 12 so that they can optionally fold upward against the tracks 12, so that they occupy less space when not in use.

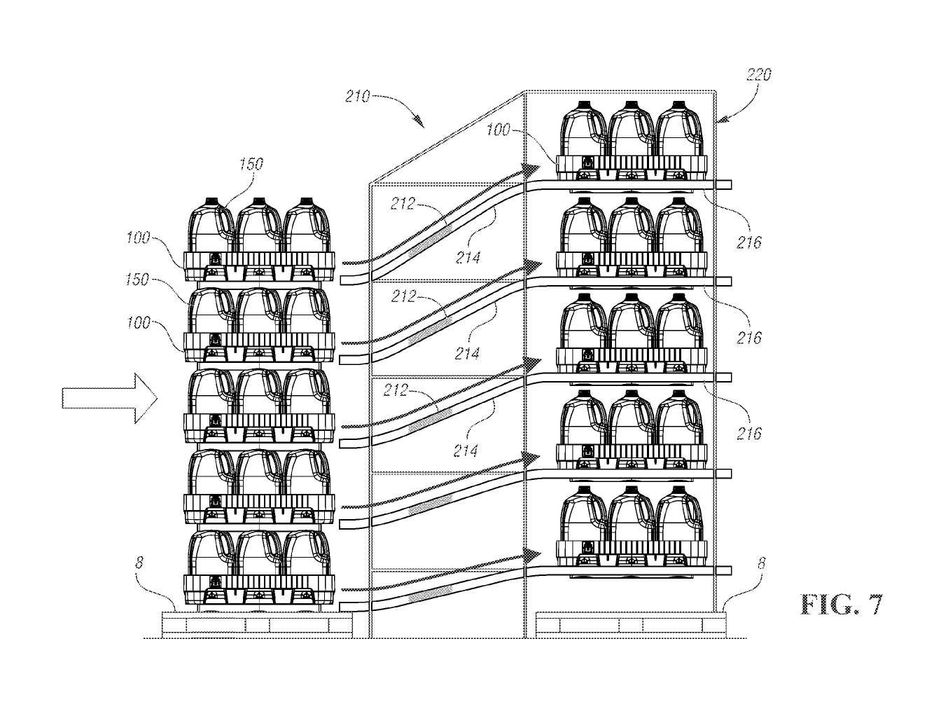

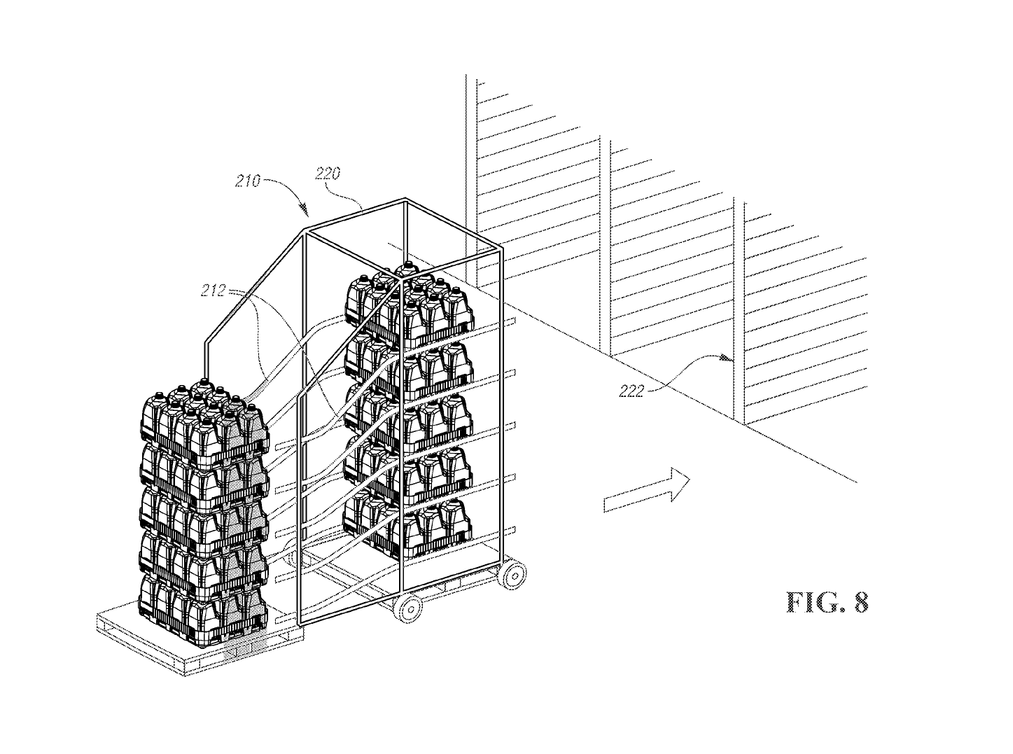

FIG. 7 is a side view of a lift system 210 according to a second embodiment. The lift system 210 includes a plurality of adjacent pairs of rails 212 projecting forward of vertical supports extending upward from a base. The rails 212 slope and curve upward from a first end where they align under the periphery of the loaded trays 100 stacked on one another and a pallet 8. The rails 212 curve up a sloped portion 214 to a shelf portion 216 on the vertical supports where the bases 112 of the trays 100 no longer engage the tops of the jugs 150 below. The system 210 can be mounted inside a container 220, which could be mobile (by mounting the base on wheels) as shown in FIG. 8 or could be the shelves of a cooler itself. The mobile container 220 can be moved into the back of a cooler 222 for vending from the front of the cooler 222.

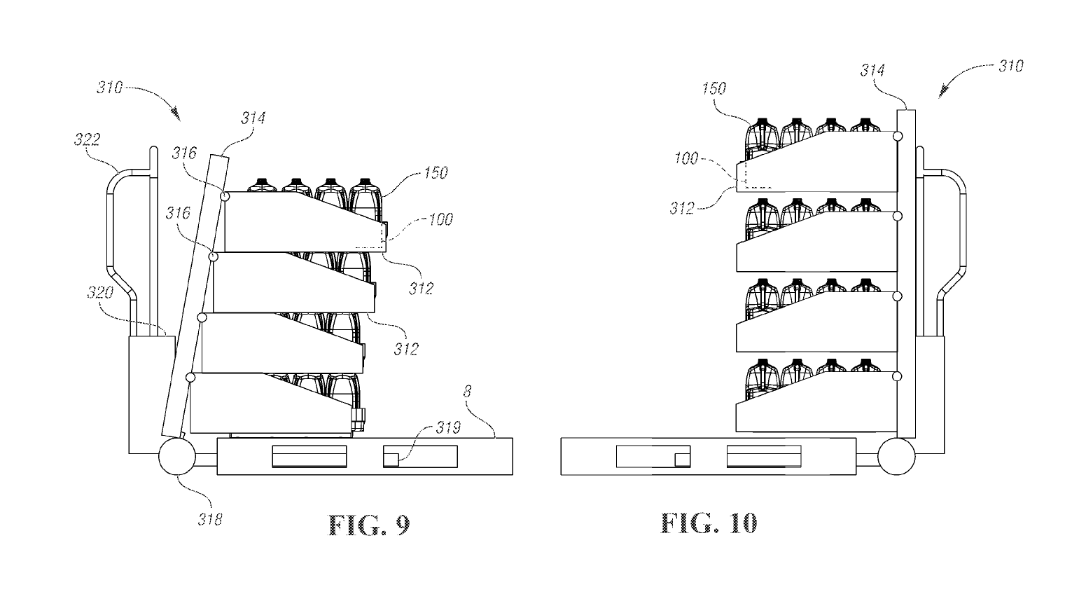

FIG. 9 shows a lift system 310 according to another embodiment. The lift system 310 includes a plurality of tines 312, which could be formed integrally as shelves. Each pair of tines 314 is pivotably secured to an upright member 314 at a point spaced vertically above the tines 314. The upright member 314 is pivotably secured via a hinge 318 to the sled lift mechanism 320. The base 319 of the sled is received in the pallet 8. The lift system 310 includes a handle 322. In FIG. 9, the tines 312 are pivoted to their forward, retracted, low position. The pairs of tines 312 each slide under a tray 100 at the periphery of the tray 100. When the upright member 314 is pivoted back and upward (the upright member 314 may be pivoted rearward manually by the sled lift mechanism 320, which may be by mechanical advantage, by hydraulics, pneumatics, or electrical power), the tines 312 lift the trays 100 such that the trays 100 are supported on the tines 312 and not on the jugs 150. A damaged jug 150 or tray 100 can then easily be removed and replaced in the trays 100, which can then be stacked again.

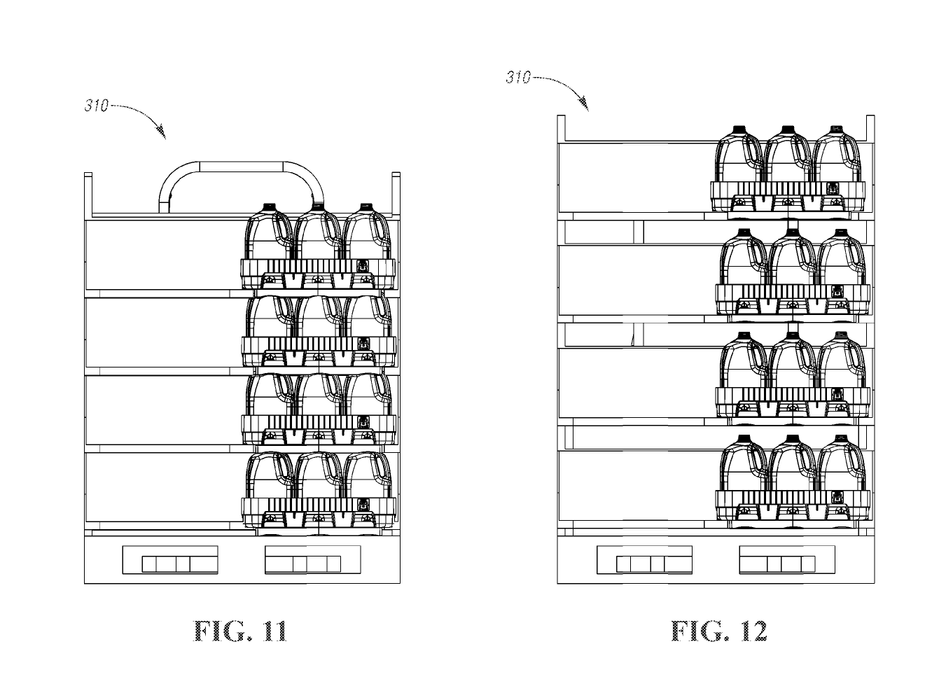

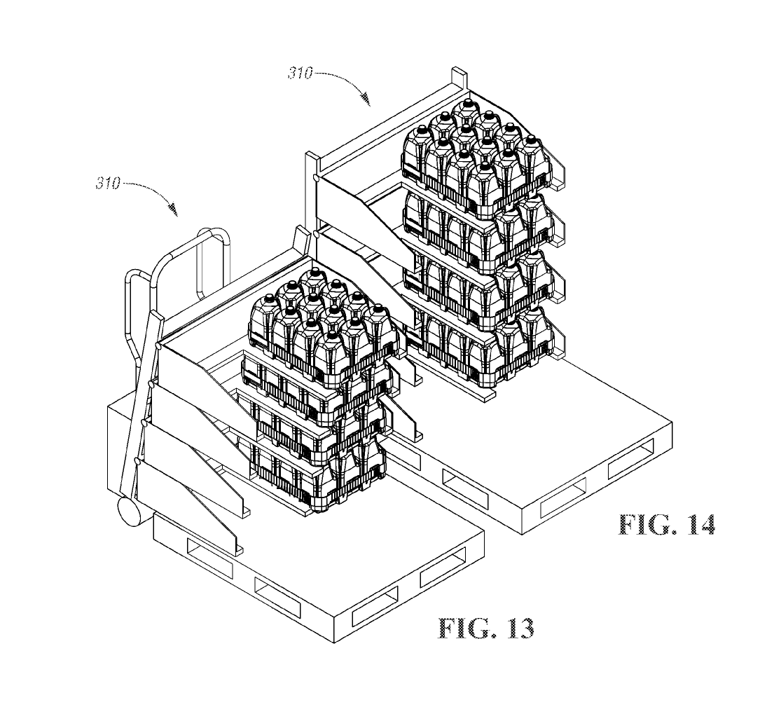

As shown in FIGS. 11 and 12, the system 310 can optionally be configured to support two stacks of trays 100, side by side. FIGS. 13 and 14 show the lift system 310 in the low position and the high position, respectively.

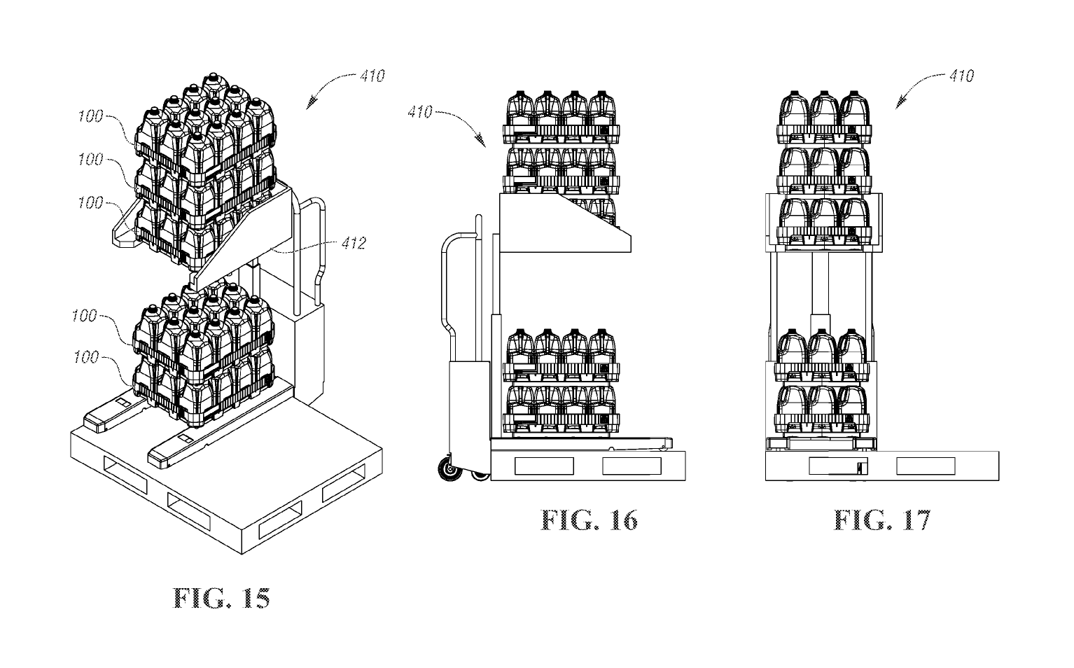

FIG. 15 shows another alternate embodiment of a lift system 410. The lift system 410 includes a pair of tines 412 (incorporated into a shelf) that can lift multiple loaded trays 100 at once off of a stack of loaded trays 100. As shown, the tines 414 can be slid under the periphery of a selected tray 100. The tines 414 can then be lifted as shown in FIGS. 16 and 17. Side walls extend upward from outer edges of the tines 414 for stability. A jug 150 can then be removed and replaced.

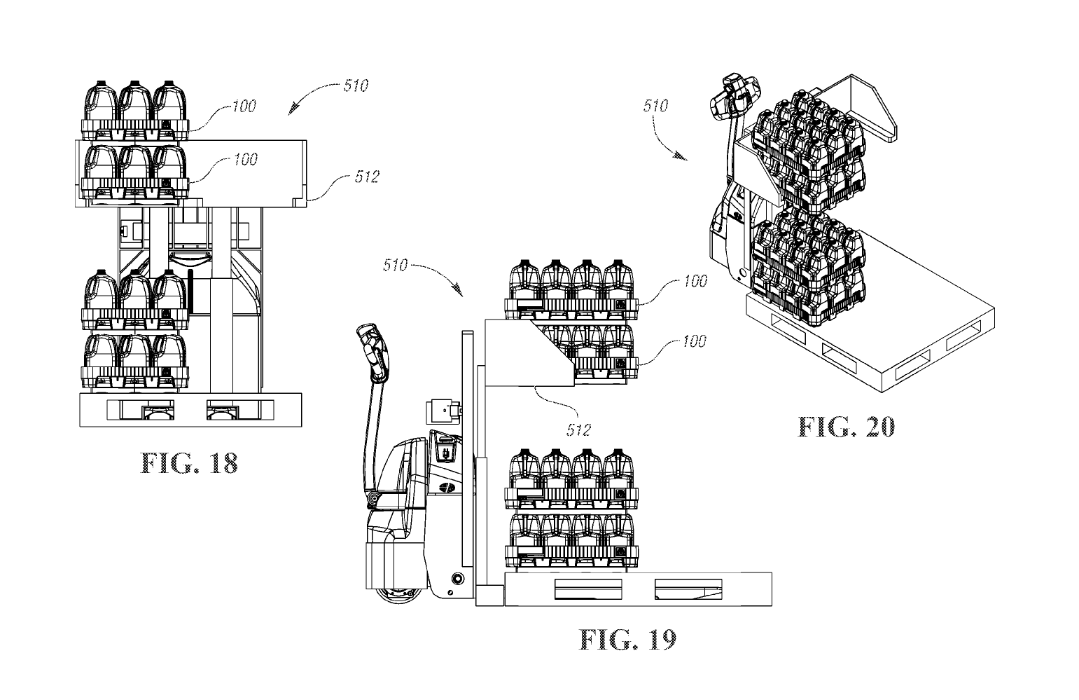

FIGS. 18-20 show a lift system 510 according to another embodiment.

The lift system includes fork tines 512 that can raise and lower a plurality of loaded trays 100. Side walls extend upward from outer fork tines 512. Center fork tines 512 are spaced between the outer fork tines 512. Trays 100 can be supported on one outer fork tine 512 and one center fork tine 512, so that two stacks of trays 100 can be lifted at once.

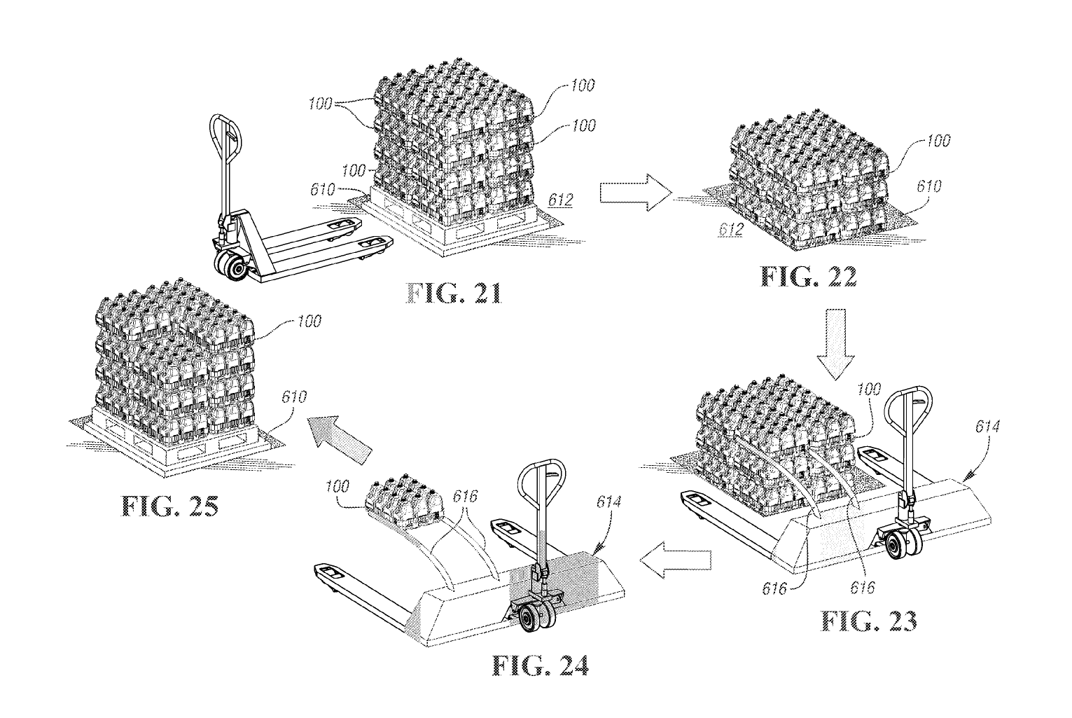

FIGS. 21-25 show an alternate system. A plate 610 is mounted above a recess in a floor 612. A sled can deliver a pallet 8 loaded with loaded trays 100 onto the plate 610. The plate 610 can then lower the stack beneath the floor 612 (FIG. 22) until a tray lifter 614 can align its tines 616 under the periphery of the desired tray 100. The tray lifter 614 can then lift and remove the tray 100, permitting access to the jug 150 and/or trays 100 therebelow. The plate 610 then raises back to floor 612 level (FIG. 25) so that the stack can be returned. Although this system is shown in use with a smaller tray (2×2), the system could also be used with the larger tray 100 of the previous figures.

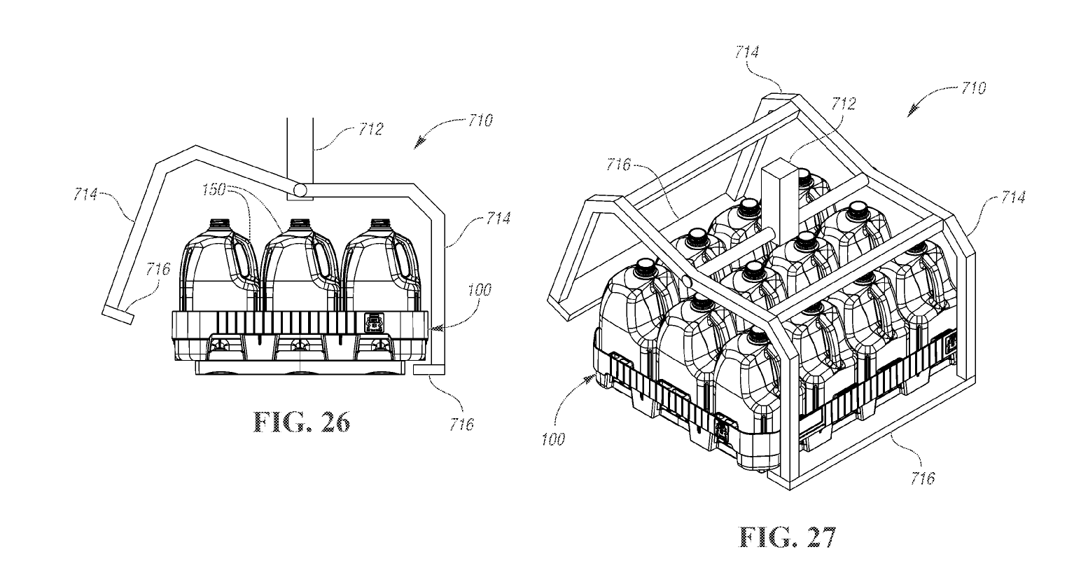

FIGS. 26 and 27 show a tray lift system 710 including a claw mounted on an arm 712. The arm 712 is movable by hydraulics or electric motors, etc. The claw includes a pair of arms 714, each including inward projections 716 for securing below the periphery of the tray 100. The lift system 710 can then lift the loaded tray 710 from a stack so that a jug 150 or tray 100 can be replaced.

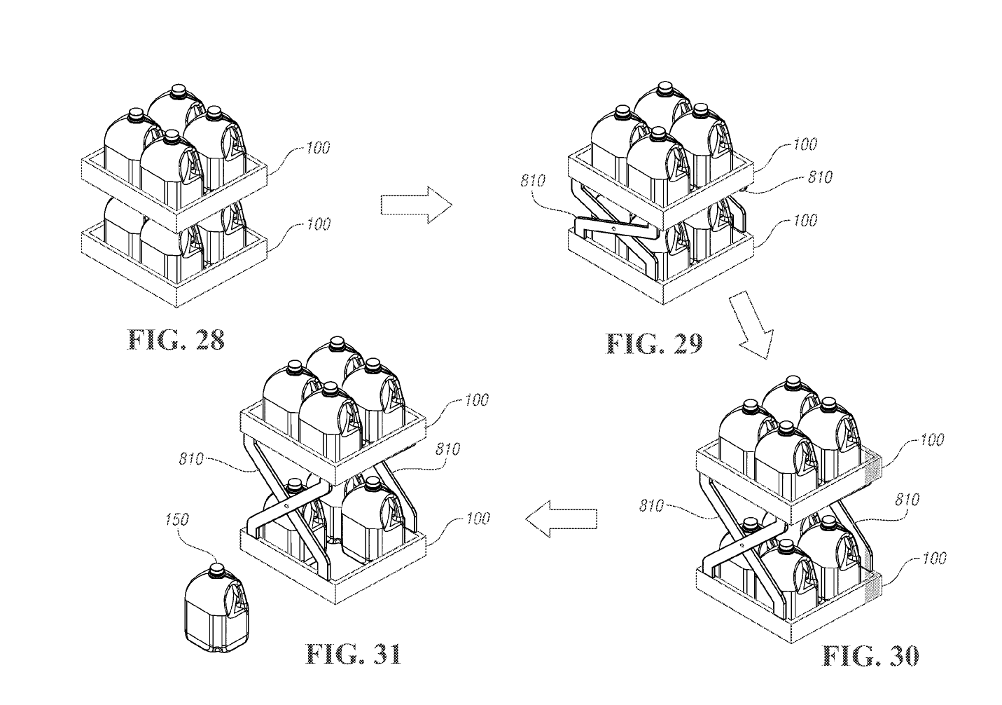

FIGS. 28-31 show a sequence for using a lift system 810 which may be a jack, such as a scissor jack (or similar device). The lift system 810 is positioned below the periphery of the tray 100 (FIG. 29). After activating the lift system 810 (via hydraulics or electric motors drawing the scissor arms together), there is separation between the upper tray 100 and the jugs 150 of the lower tray. The jugs 150 can be removed from the lower tray 100 while the upper tray 100 is in the upright position.

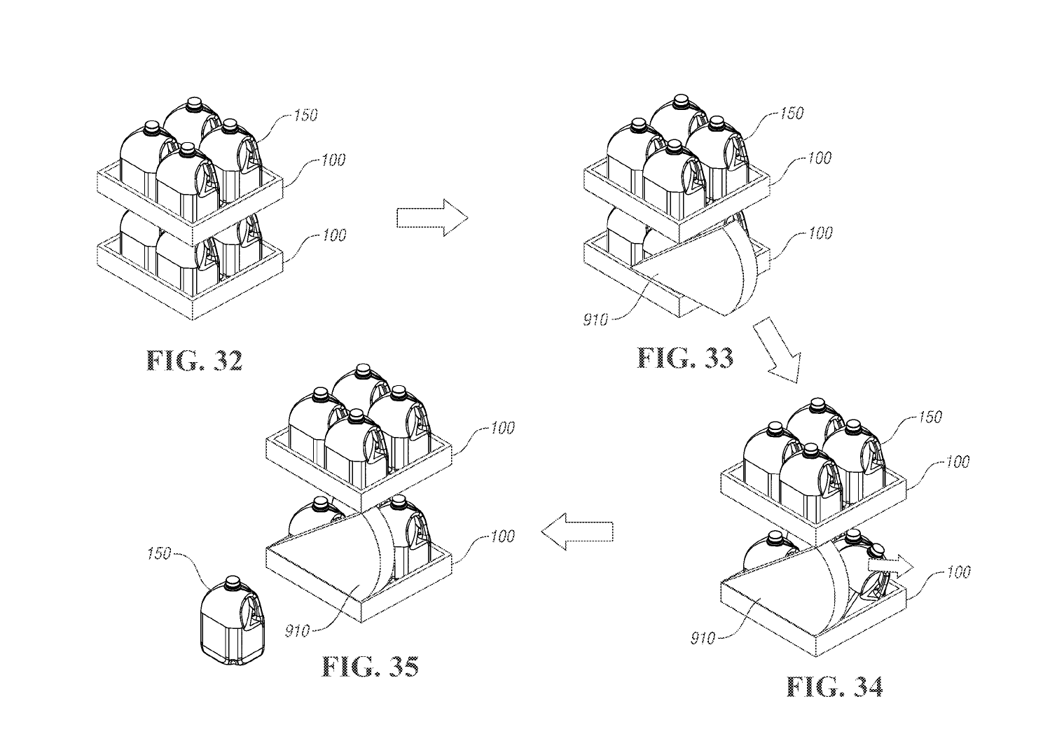

FIGS. 32-35 show a sequence for separating the trays 100 using a wedge 910 along a periphery of the trays 100, as shown in FIGS. 33 and 34. The wedge 910 may be moved relative to the trays by hydraulics or electric motors. The wedge 910 creates a little space between the trays 100 for removal of the jugs 50.

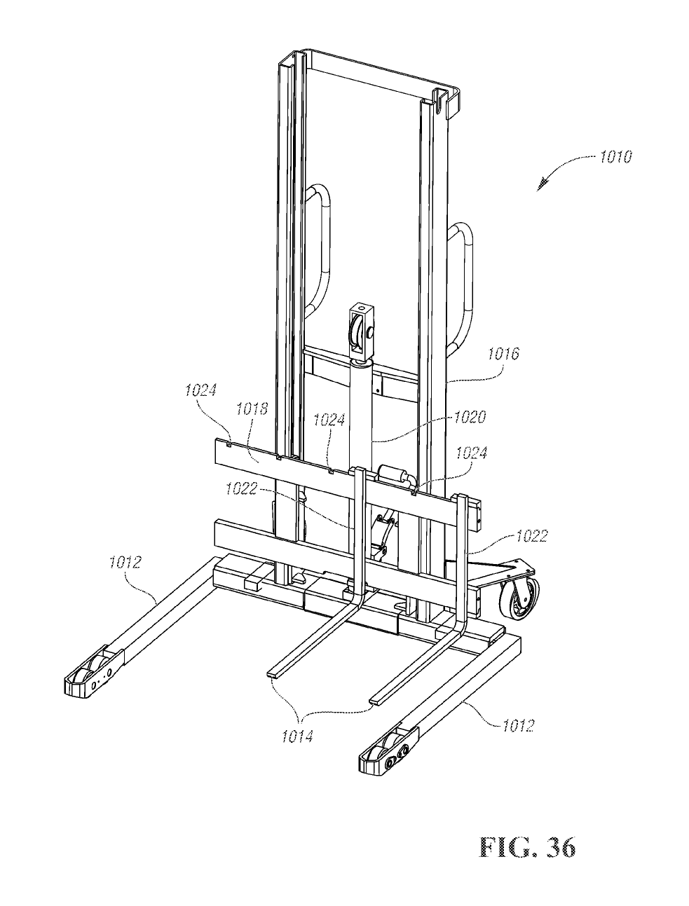

FIG. 36 shows a lift system 1010 according to a tenth embodiment. The lift system includes a base 1012 having wheels or casters and a pair of movable tines 1014. A vertical structure 1016 extends upward from the base 1012 and supports a front bracket 1018 mounted to move vertically relative to the vertical structure 1016. A lift mechanism 1020, such as a manually-operated hydraulic system, is configured to lift the front bracket 1018 relative to the vertical structure 1016. The lift mechanism 1020 could also be a power hydraulic or electric or other known lift mechanism. A pair of tine brackets 1022 are horizontally slidable on the front bracket 1018. The tines 1014 extend forward from lower ends of the tine brackets 1022. Each of the tine brackets 1022 interlocks with one of a plurality of spaced-apart notches 1024 on the front bracket 1018 to keep the tine brackets 1022 in the selected location. The tine brackets 1022 can be slid manually horizontally into selected ones of the notches 1024. Alternatively, hydraulics or an electric motor or linkages could be used to move the tine brackets 1022 to each of the selectable horizontal positions. In FIG. 36, the tine brackets 1022 are in a first position.

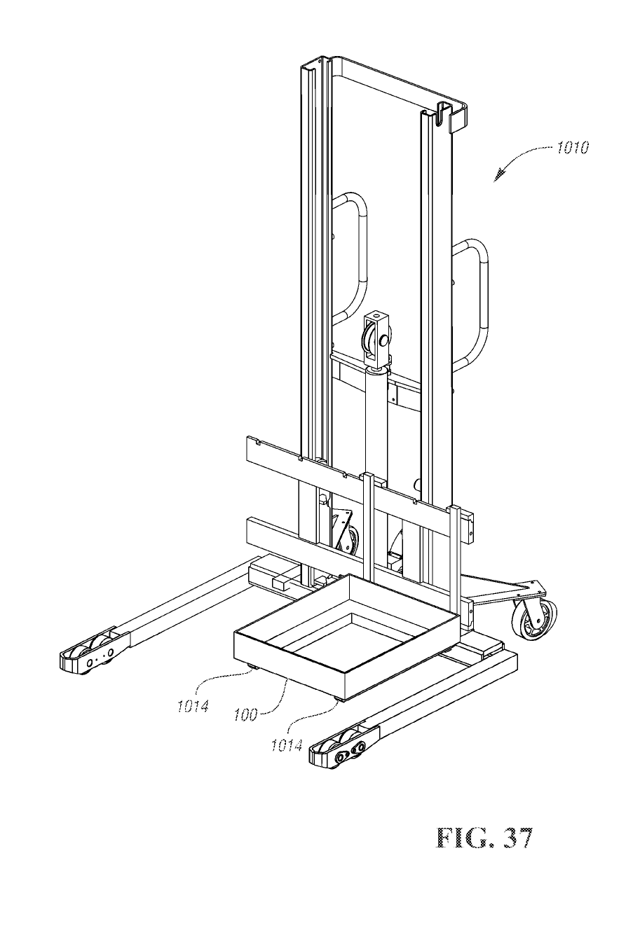

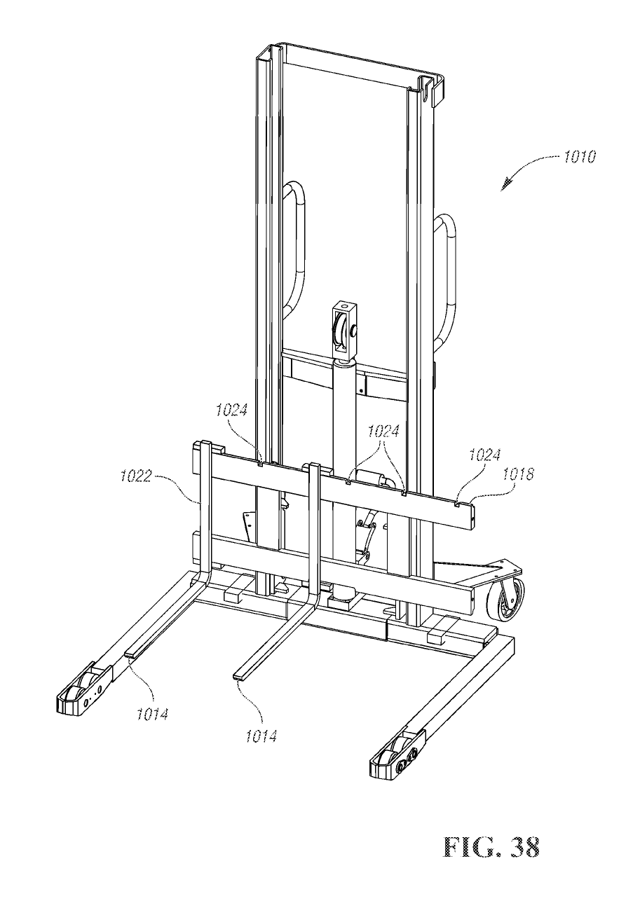

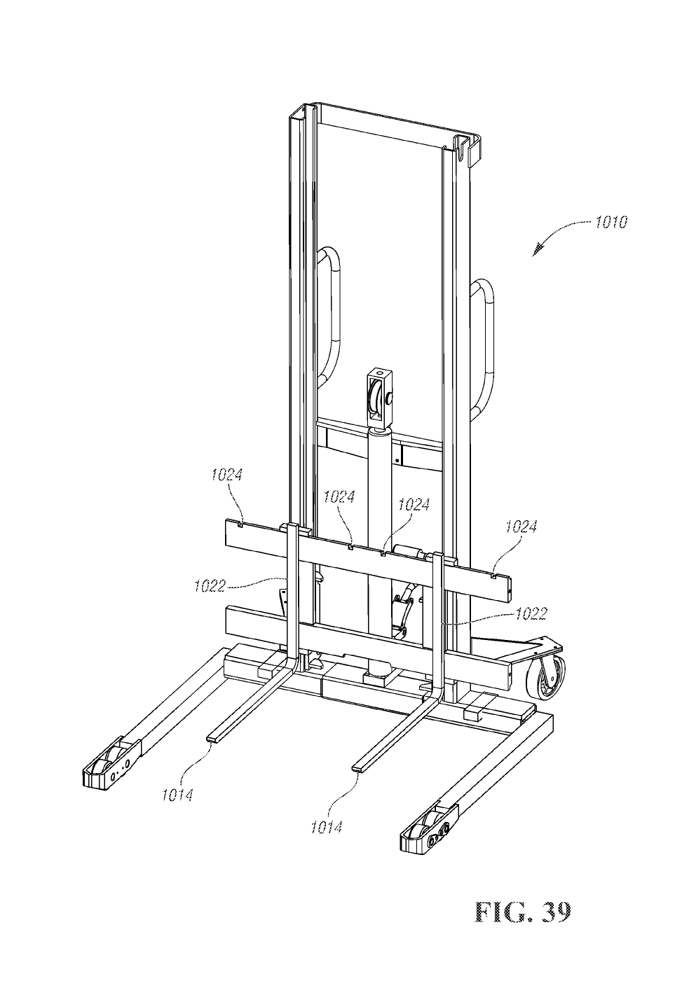

FIG. 37 shows the lift system 1010 of FIG. 37 with a tray 100 engaged by the tines 1014 in the first position. FIG. 38 shows the lift system 1010 with the tines 1014 slid to a second position, where they are received in different notches 1024. FIG. 39 shows the lift system 1010 with the tines 1014 reconfigured to a third position.

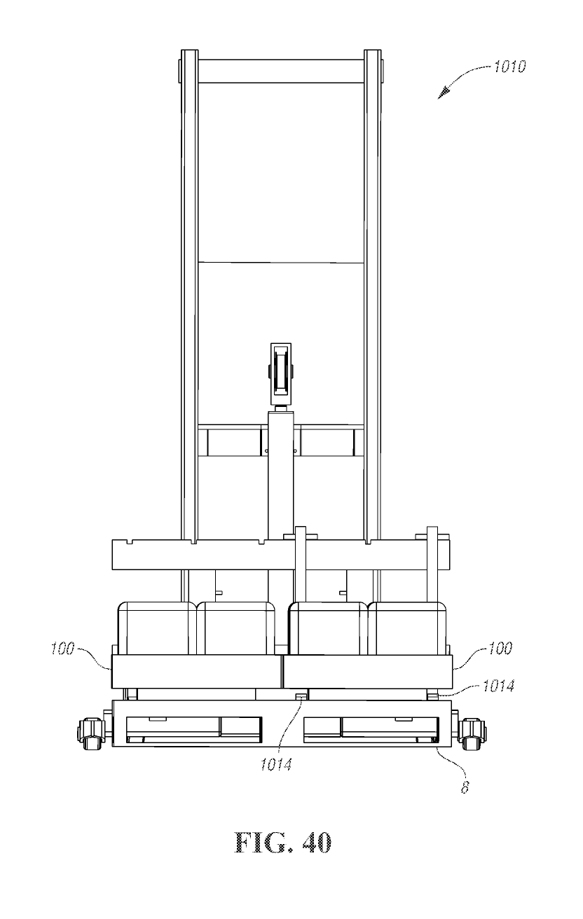

FIG. 40 shows the lift system 1010 with the tines 1014 in the first position and with the tines 1014 engaging one of two trays 100 on a pallet 8. The trays 100 in this example fit four on the pallet 8. By adjusting the tines 1014 between the first position and the second position, the lift system 1010 can retrieve trays 100 from one stack of trays 100 or the adjacent stack of trays 100 without disturbing the adjacent stacks. Again, this enables a single user to lift one or more trays 100 off of a stack of trays 100, for up-stacking, down-stacking, or accessing a tray 100 that is lower in the stack, etc.

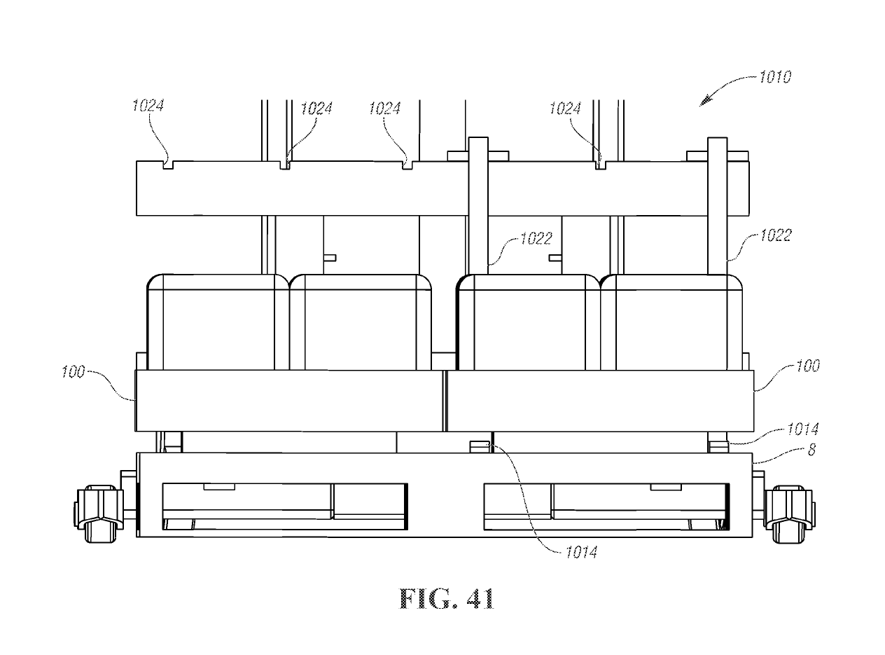

FIG. 41 is an enlarged front view of the lift system 1010 and trays 100 of FIG. 40.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A lift system comprising:
a pair of vertical tracks;
a plurality of tines extending horizontally outward from each of the vertical tracks, wherein the plurality of tines are selectively movable upward on the vertical tracks.

2. The lift system of claim 1 wherein the vertical tracks are mounted to a wall.

3. The lift system of claim 1 wherein the plurality of tines are pivotably secured to the tracks so that they can fold toward the vertical tracks.

4. The lift system of claim 1 in combination with a plurality of trays stacked on one another, wherein each of the adjacent pair of the plurality of tines engages a different one of the plurality of trays.

5. The combination of claim 4 wherein each of the plurality of trays includes a base, a pair of opposed side walls extending upward from the base and a pair of opposed end walls extending upward from the base, wherein the base includes a raised periphery sized to receive one of the adjacent pair of the plurality of tines.

6. The combination of claim 5 wherein the plurality of tines are movable from a low position where they can engage each of the trays to a raised position where the trays are not supported on one another.

7. The combination of claim 6 wherein contents of any of the trays can be removed when the plurality of tines are in the raised position.

8. The lift system of claim 1 wherein the plurality of tines are movable from a low position in which horizontally-adjacent pairs of the plurality of tines are vertically spaced from one another by a first distance, to a raised position in which the horizontally-adjacent pairs of the plurality of tines are vertically spaced from one another by a second distance larger than the first distance.

9. The lift system of claim 1 wherein the plurality of tines includes a plurality first tines on a first vertical track of the pair of vertical tracks, wherein the plurality of first tines are movable from a low position in which plurality of first tines are vertically spaced from one another by a first distance, to a raised position in which the plurality of first tines are vertically spaced from one another by a second distance larger than the first distance.

10. A lift system comprising:
a base;
vertical supports extending upward from the base;
a plurality of pairs of rails supported above the base by the vertical supports and projecting forward from the vertical supports, wherein the rails slope upward to the vertical supports, wherein the plurality of pairs of rails are spaced from one another to engage lower surfaces of trays stacked on one another.

11. The lift system of claim 10 further including wheels mounted to the base.

12. A lift system comprising:
a base;
an upright member extending upward from a rear portion of the base and pivotable relative to the base;
a plurality of pairs of adjacent tines pivotably secured to the upright member at points vertically spaced above the respective pair of adjacent tines, the plurality of pairs of adjacent tines projecting forward from the upright member.

13. The lift system of claim 12 wherein the upright member is pivotable from a leaning position to an upright position, wherein the pairs of adjacent tines are vertically spaced from one another by a first distance when the upright member is in the leaning position and by a second distance, greater than the first distance, when the upright member is in the upright position.

14. The lift system of claim 13 in combination with a plurality of trays each having a base and a plurality of walls extending upward from the base, wherein each of the pair of adjacent tines engages a lower surface of one of the plurality of trays.

15. A lift system comprising:
a base;
a vertical structure extending upward from the base;
a front bracket mounted to move vertical relative to the vertical structure;
at least one tine bracket mounted to the front bracket to move horizontally relative to the front bracket; and
a tine projecting forward from each of the at least one tine bracket.

16. The lift system of claim 15 wherein the at least one tine bracket includes a pair of tine brackets movable independently relative to the front bracket.

17. The lift system of claim 16 wherein the front bracket includes a plurality of notches engaged by the pair of tine brackets to secure the pair of tine brackets in each of a plurality of positions relative to the front bracket.
